(19) United States
(12) Patent Application Publication
(10) Pub. No.: US 2015/0083797 A1
(43) Pub. Date: Mar. 26, 2015

(54) VERIFICATION OF PHYSICAL ENCRYPTION TAGGANTS USING DIGITAL REPRESENTATIVES AND AUTHENTICATIONS THEREOF

(71) Applicant: APDN (B.V.I) Inc., Tortola (VG)

(72) Inventors: Phidung H. Tran, East Setauket, NY (US); MingHwa Benjamin Liang, East Setauket, NY (US); Lawrence Jung, Forest Hills, NY (US); James A. Hayward, Stony Brook, NY (US)

(73) Assignee: APDN (B.V.I.) INC., Tortola (VG)

(21) Appl. No.: 14/398,848

(22) PCT Filed: May 9, 2013
(86) PCT No.: PCT/US13/40320

§ 371 Date: Nov. 4, 2014

Related U.S. Application Data
(60) Provisional application No. 61/644,939, filed on May 9, 2012.

(51) Int. Cl. G06Q 30/00; G06K 19/18

(52) U.S. Cl. CPC G06Q 30/0185; G06K 19/18
USPC 235/375; 235/487

(57) ABSTRACT

A verifiably identifiable object that includes a primary taggant encoding a readable encrypted first identifier of the object encrypted by a first method and a secondary taggant encoding a readable encrypted second identifier of the object optionally encrypted by a second method. The primary taggant can be a physical identification taggant, such as DNA including an authentication sequence, and the secondary taggant can be a digital identification taggant. The digital identification taggant encodes information validating the physical identification taggant, such as by referencing information embodied in the physical taggant, e.g. the defined sequence within the DNA. Also included is a method and system for identification and/or authentication of an object that includes a primary taggant encoding a readable encrypted first identifier of the object encrypted by a first method and a secondary taggant encoding a readable encrypted second identifier of the object encrypted by a second method.

### RELATED APPLICATIONS

This application claims the benefit of U.S. provisional patent application Ser. No. 61/644,939 filed May 9, 2012 the disclosure of which is herein incorporated by reference in its entirety.

### TECHNICAL FIELD

The inventive concept relates to steganographic encryption of the identity or other characteristic of taggants for rapid digital authentication of unique objects or items to which they are attached, wherein the encrypted information permits rapid identification and verification of the object or item.

### DISCUSSION OF THE RELATED ART

Merchandise and other objects can be tracked and authenticated using taggants carrying encrypted information related to the item bearing the particular taggant. One commonly used type of identification tag is a barcode. A barcode is a representation of data by varying the widths and spacing of parallel lines. When used as an identification tag on an object, the barcode carries encoded information relevant to that object that can be read by a barcode decoder or reader. An early version of this technique was disclosed by Woodland and Silver in 1952 in U.S. Pat. No. 2,612,994. This technology has evolved to store more information using two-dimensional barcodes with different geometric symbols. For example, matrix codes or QR codes are two dimensional barcodes. Nucleic acids can be used to carry encrypted information for authentication of merchandise and other items, see for instance European Patent 1 568 783 B2 to B. Liang: A nucleic acid based steganography system and application thereof.

QR Codes (“Quick Read” codes) were first used by Denso, a Toyota subsidiary in the 1990's to track automobiles during manufacturing by allowing their contents to be decoded at high speed. QR Codes became one of the most popular two-dimensional barcodes. Unlike the original barcode that was designed to be interrogated by a beam of light, the QR code is detected as a 2-dimensional digital image by a semiconductor-based image sensor that can be digitally analyzed by a programmed processor. The processor locates reference squares at three corners of the QR code, and processes the image after normalizing its size, orientation, and angle of viewing. The small dots in the code can then be converted to binary numbers and their validity checked with an error-correcting code.

Similarly, RFID tags (Radio-Frequency identification tags) store data electronically or as a bit stream which can be read wirelessly by machine outside a line of sight. See for example U.S. Pat. No. 6,043,746 to Microchip Technologies Incorporated. RFIDs can be extended range RFIDs: see for instance, U.S. Pat. No. 6,147,606 or for restricted range RFIDs, see for instance, U.S. Pat. No. 6,097,301. Unlike barcodes, RFIDs need not be in a line of sight of the reader and can even be embedded in the object being interrogated. Although these identification tags are useful for generic identification and tracking, they can be easily copied. There is a need for more secure forms of taggant verification for authentication of tagged objects, particularly high value merchandise.

### SUMMARY

In an embodiment the present inventive concept provides a verifiably identifiable object that includes a primary taggant encoding a readable encrypted first identifier of the object encrypted by a first method; and a secondary taggant encoding a readable encrypted second identifier of the object optionally encrypted by a second method. In one embodiment, the primary taggant is a physical identification taggant, such as for instance DNA including an authentication sequence, and the secondary taggant is a digital identification taggant. In another embodiment, the digital identification taggant encodes information validating the physical identification taggant, such as by referencing information embodied in the physical taggant, e.g. the defined sequence within the DNA.

In an embodiment, the inventive concept provides a verifiably identifiable object that includes a primary taggant encoding a readable encrypted first identifier of the object encrypted by a first method; and a secondary taggant optionally encoding a readable encrypted second identifier of the object encrypted by a second method, wherein the primary taggant includes one or more of a nucleic acid (which can include one or more of a single stranded DNA molecule, a double stranded DNA molecule, a DNA oligonucleotide, or an RNA molecule), an amino acid, a peptide, a polypeptide, a protein, a trace element or the like.

In an embodiment, the inventive concept provides a verifiably identifiable object that includes a primary taggant encoding a readable encrypted first identifier of the object encrypted by a first method; and a secondary taggant optionally encoding a readable encrypted second identifier of the object encrypted by a second method, wherein the primary taggant includes a nucleic acid, and the nucleic acid includes a sequence encoding the readable first identifier.

In an embodiment, the inventive concept provides a verifiably identifiable object that includes a primary taggant encoding a readable encrypted first identifier of the object encrypted by a first method; and a secondary taggant optionally encoding a readable encrypted second identifier of the object encrypted by a second method, wherein the secondary taggant is a digital identifier that can be encrypted and can be included in one or more of a bar code, a magnetic stripe, a hologram, an interference pattern, an optical medium, a microdot, a QR code or an RFID.

In an embodiment, the inventive concept provides a method of identification and/or authentication of an object: the method includes providing a primary taggant encoding a readable encrypted first identifier of the object, such as for instance a DNA molecule having an authentication sequence, encrypted by a first method; providing a secondary taggant encoding a readable encrypted second identifier, such as the encrypted digital DNA sequence of the object, optionally encrypted by a second method; providing a searchable secure database encoding the second identifier of the object; reading the first identifier and the second identifier and accessing the database to search for the encrypted second identifier; comparing the reading of the first identifier with the second identifier from the searchable secure database; and thereby identifying the object as authentic or counterfeit. In one embodiment of the above-disclosed method, the primary taggant includes one or more of a nucleic acid, an amino acid, a peptide, a polypeptide, a protein, a trace element or the like. In another embodiment, of the methods of the inventive concept, the primary taggant includes a nucleic acid, and the nucleic acid includes a sequence encoding the readable first identifier. In still another embodiment, the secondary taggant is a digital identifier that can be encrypted and can be included in one or more of a bar code, a magnetic stripe, a hologram, an interference pattern, an optical medium, a microdot, a QR code or an RFID.

In an embodiment, the inventive concept provides a method of verification of the authenticity of an object: the method includes providing a primary taggant encoding a readable encrypted first identifier of the object, such as for instance a DNA molecule having an authentication sequence, encrypted by a first method; providing a secondary taggant encoding a readable encrypted second identifier, such as the encrypted digital DNA sequence of the object, optionally encrypted by a second method; providing a searchable secure database encoding the second identifier of the object; reading the second identifier and accessing the database to search for the encrypted second identifier; matching the reading of the second identifier with an identifier from the searchable secure database; and thereby identifying the object as authentic. As a second optional step, the encrypted first identifier can be read and compared to the identifier listed in the database for authentication as further confirmation of the authenticity of the object.

In an embodiment, the inventive concept provides a system for identification and/or authentication of an object, the system includes a primary taggant encoding a readable encrypted first identifier of the object, such as for instance a DNA molecule having an authentication sequence, encrypted by a first method; a secondary taggant optionally encoding a readable encrypted second identifier, such as the encrypted digital DNA sequence of the object, encrypted by a second method; and a searchable secure database encoding the second identifier of the object. In one embodiment of the above-disclosed system, the primary taggant includes one or more of a nucleic acid, an amino acid, a peptide, a polypeptide, a protein, a trace element or the like. In another embodiment, of the system of the inventive concept, the primary taggant includes a nucleic acid, and the nucleic acid includes a sequence encoding the readable first identifier. In still another embodiment, the secondary taggant is a digital identifier that can be encrypted and can be included in one or more of a bar code, a magnetic stripe, a hologram, an interference pattern, an optical medium, a microdot, a QR code or an RFID.

### DEFINITIONS

As used in this disclosure, a small molecule is a low molecular weight (less than about 500 Daltons) organic compound that may serve as an enzyme substrate or regulator of biological processes, with a size on the order of 1 nanometer. These compounds can be natural molecules, such as secondary metabolites, synthetic molecules, such as for instance an antiviral compound.

Biopolymers such as nucleic acids, proteins, and polysaccharides (such as starch or cellulose) are not small molecules, although their constituent monomers ribonucleotides or deoxyribonucleotides, amino acids, and monosaccharides, respectively are small molecules. Short oligomers (of less than 500 Daltons molecular weight) such as dinucleotides, and short peptides and polypeptides, such as the antioxidant glutathione, and disaccharides such as sucrose are small molecules.

Encoding information as used herein refers to storing information in a retrievable form for authentication or validation.

A readable coded identifier as used herein refers to encrypted information useful for identifying an object or item that can be readily decoded.

A taggant as used herein refers to a marker, which can be any suitable marker having sufficient coding capacity to uniquely identify an object or item.

### DETAILED DESCRIPTION

The methods and systems of the present inventive concept provide authentication by adding layers of security on the tag by embedding physical encryption taggants as well as encrypting their digital representatives directly into the content of the tag. The DNA security solutions of the present inventive concept protect products, brands and intellectual property from counterfeiting and diversion.

In an embodiment the present inventive concept provides a DNA-secured form of the encrypted code, which can be by any suitable encryption method and coded in a secure format, such as without limitation a QR code or an RFID. The encrypted information corresponds to the DNA authentication sequence and can be encrypted in any suitable coding system, such as for instance, and without limitation, an Advanced Encryption Standard, Secure Hash Algorithm, 3DES, Aria, Blowfish, Camellia, CAST, CLEFIA, CMAC, Ghost 28147, RFC 4357, RFC 4490, IDEA (International Data Encryption Algorithm), Mars, MISTY1, Rabbit, RC2, RC4, RC5, RC6, Rijndael, RSA, Seed, Skipjack, Sober, Seal, Twofish and the W7 algorithm.

The DNA or other secure form of the encrypted code, such as for instance, a biological molecule, e.g. a nucleic acid, an amino acid, a peptide, a polypeptide, a protein, or a trace element marker, or other suitable marker such as an identifiable small molecule, is incorporated into the matrix of the physical tag which carries the taggant, this can be by surface marking such as with a varnish or an ink applied by any suitable method, such as or instance, but not limited to by Inkjet Ink, Flexo Ink, toner, epoxy ink, lithography, coating with a lacquer, plasma treatment and deposit of the marker onto the matrix, on the fibers of woven textiles, or by injection molding of a material having the DNA or other suitable taggants, such as, but not limited to a nucleic acid, an amino acid, a peptide, a polypeptide, a protein, a trace element marker incorporated into the matrix material to be injection molded.

Theoretically, DNA can encode two bits per nucleotide or 455 exabytes per gram (that is ten to the eighteenth power per gram) of single-stranded DNA and in contrast to most digital storage media, DNA storage is not limited to a planar layer and is often readable despite degradation in less than ideal conditions over huge time spans. Suitable DNA molecules and methods for incorporation useful in the practice of the present inventive concept include the DNA molecules methods disclosed in U.S. Pat. Nos. 8,124,333; 8,372,648; 8,415,164; 8,415,165; 8,420,400 and 8,426,216 to Applied DNA Sciences, Inc.

In an embodiment, this new code is a security tool named digitalDNA™ that utilizes the flexibility of mobile communications, the instant accessibility of secure, cloud-based data, and the absolute certainty of DNA to make item tracking and authentication fast, easy and definitive, while providing the opportunity to create a new and exciting customer interface.

In an embodiment, the DNA-secured encrypted code uses forensic authentication of a DNA marker, such as a botanical DNA marker, sequence-encrypted within a secure QR code, and physically included within the ink used to print the code. The DNA marker can be any DNA marker, natural or synthetic or semi-synthetic. A semi synthetic marker DNA is a DNA molecule having a natural and a non-natural sequence, whether assembled by ligation of synthetic and natural fragments, or by re-ligation of fragments of a natural DNA in a random or predefined order to create a new sequence. For instance, a plant DNA molecule having the natural plant DNA sequence can be digested with a restriction enzyme and the digest can be ligase treated to re-order the fragments in a random order thus creating a non-natural sequence. The QR code may encode supplementary encrypted information or other data, such as the serial number of the item or object tagged, the manufacturer, the date, location and any other desired data specific to the item or object carrying the QR code. The resulting pattern can be scanned using a smartphone (such as, but without limitation, an iPhone® or Droid) installed with an application program capable of scanning and decoding the information in the pattern. These mobile scans can be performed anywhere along the supply chain without limitation. The application software (commonly referred to as an “App”) reads the digital taggant, which is the digital representative of the physical taggant, such as a DNA sequence, encoded in QR symbols. This method extends the technology beyond verification to digital track-and-trace for logistic purposes.

In an embodiment, the inventive concept also provides a DNA-secured encrypted code sequence-encrypted within a secure QR code, and physically included within the ink used to print the code and a suitable additional marker, such as, for instance a fluorescent marker. In an embodiment, the DNA encoding the secured encrypted code can be located with the additional marker, instead of included in the secure QR code or other physical encryption code.

In an embodiment, the inventive concept provides a verifiably identifiable object that includes a primary taggant encoding a readable encrypted first identifier of the object encrypted by a first method, such as a DNA molecule encoding a DNA sequence unique to the item to which it is attached; and a secondary taggant optionally encoding a readable encrypted second identifier of the object encrypted by a second method. The secondary taggant can be any suitable taggant, such as for instance a bar code, a magnetic stripe, a hologram, an interference pattern, an optical medium, a microdot, a QR code or an RFID. The secondary taggant can encode an encrypted second security code sequence unique to the item to which it is attached, or alternatively, the secondary taggant can encode an access key used to access a secure online server for verification. The verification can be by comparison of the DNA sequence of the primary taggant encoding a readable encrypted first identifier stored in a computer database. The database can be any database, such as for instance a database on a server of a local area network or a cloud-based server accessible only to authorized users.

In an embodiment, the scan checks in wirelessly with a secure database in a “secure cloud” such as a “private cloud” accessible only to the customer, and displays the resulting analysis back on a computer monitor or a smartphone screen. Tracking information is fed into “tunable algorithms” that use pattern recognition to automatically identify supply-chain risks, for counterfeits or product diversion. Rapid-reading reporters associated with the DNA marker can also be embedded in the ink, and prevent the secure code from being digitally copied. The DNA markers included in such DNA-secured form of the encrypted codes facilitates forensic authentication where absolute proof of originality is required. Forensic authentication of the DNA in the tag must match the sequences found in the decrypted DNA-secured form of the encrypted code. Applications such as cloud computing, mobile devices, and logistics are in need of the highest security available, including advanced encryption of data in transit and at rest. The DNA-secured encrypted codes can be used to track individually packaged items, such as drugs or luxury goods, when the space on the item is available to print the code matrix. On items too small for the matrix, such as microchips, the DNA-secured encrypted codes can be used on lot shipments.

In an embodiment, the technology of the present inventive concept avoids the risks of phishing scams to which non-secure QR codes are notoriously vulnerable, while other indicia such as geolocation and time-stamping throughout the supply chain provide further authenticity trails. The ubiquity of the iPhone® platform allows the consumer to participate in the authentication scheme, quickly and easily. In addition, end-users can confirm freshness and expiration dates, connect to real-time or video technical support, identify local resources, easily place reorders, and participate in peer-to-peer selling.

In an embodiment of the inventive concept a characteristic of a physical taggant, such as for instance, and without limitation, a critical sequence of a DNA molecule (the identifying sequence that matches the secondary code) such as a SigNature® DNA sequence is encrypted into a digital component which can be for instance a bar code, a QR code or an RFID. This digital content is then incorporated into a label. At the same time the physical taggant, such as SigNature® DNA can also be printed onto the label in an ink or via a carrier or by chemical attachment. The object carrying the label can then be instantly verified by comparing the encrypted digital information with information stored on a secure database, such as SQL. SQL is a relational database for storage and retrieval of data on a server which can be on a local or a wide area network, or can be cloud based. The primary query languages used are T-SQL and ANSI-SQL and are compatible with a variety of operating systems, including but not limited to Windows XP, VISTA, Windows 7, Server 2003, Server 2008, R2, and Server 2012. In addition, the full authentication can occur by reading the SigNature® DNA (and comparison to the digital DNA information. A match indicates the item is authentic, a non-match/absence indicates the item is not authentic. In an embodiment the critical sequence of the DNA molecule is in a range from about 4 bases to about 20,000 bases. Alternatively, the critical identifying sequence of the DNA molecule that matches the barcode can be in a range from about 10 bases to about 5,000 bases, or in a range from about 14 bases to about 2,000 bases.

In an embodiment, the DNA-secured form of the encrypted code platform is designed to meet compliance specifications defined by the PCI (Payment Card Industry) Security Standards Council, the new and strict standards developed for handling credit card transactions. In another embodiment, DNA-secured form of the encrypted code platform of the inventive concept meets the stringent requirements of HIPAA (Health Insurance Portability and Accountability Act), for protecting personal health information. A related product, SigNature® DNA is a botanical DNA marker used to authenticate products in a unique manner that essentially cannot be copied, and provide a forensic chain of evidence that can be used in a court of law.

In an embodiment, the DNA-secured form of the encrypted code can be in a completely synthetic DNA molecule of a non-natural sequence. Alternatively, the synthetic DNA molecule can be designed and synthesized to encode the required information and obviate the need for any database storage. See for instance Church, G., Y. Gao, S. Kosuri (2012) Next-Generation Digital Information Storage in DNA Science vol. 337(6102) page 1628 et seq. in the issue of 28 Sept. 2012 (ePub 16 Aug. 2012) for details of the storage capacity of DNA sequences. See also the associated Supplementary materials for Materials and Methods, Supplementary Text, Figs. S1 and S2, Tables S1 to S3 and References (15-35). The authors state that digital information is accumulating at an astounding rate, straining the ability to store and archive it. Further, DNA is among the most dense and stable information media known. The development of new technologies in both DNA synthesis and sequencing make DNA an increasingly feasible digital storage medium. Church et al. describe the development of a strategy to encode arbitrary digital information in DNA, encoded a 5.27-megabit book using DNA microchips, and decoded the entire DNA encoded book by using next-generation DNA sequencing. This capacity for storage of information in a collection of DNA molecules provides potentially unlimited information relevant to a particular item, such as the make, model and serial number; the date of manufacture, the supplier, location and timing of incorporation of all parts used in manufacture and the location and timing of all transit points in the stream of commerce, by addition of new DNA sequences with the new information at each location in the stream of commerce.

The DNA-secured encrypted code can be sold directly and through existing channels to any commodity, bulk item or individual item supply business. Businesses that can benefit from the methods and systems of the present inventive concept include local, national and multinational, businesses that may be involved in any kind of business with a supply chain, including for example, but not limited to: electronics, machinery and components, such as ball bearings, arms and weaponry, connectors, vehicles and vehicle parts (such as bodies, engines and wheels etc.), connectors, fasteners; and also including packaging, food and nutritional supplements, pharmaceuticals, textiles, clothing, luxury goods and personal care products, to name just a few.

### EXAMPLES

### Example 1

The inclusion of a unique DNA marker as two forms of encryption, one in the QR code and the other in the ink used to print the QR code for authentication thereof.

The first form is the encryption of a unique DNA sequence into a digital representative which is incorporated into the information content of the QR code. The second form of encryption is embedded in the printing ink using a unique physical DNA sequence. The QR code is printed using this ink which contains that unique physical DNA sequence. For rapid screening of the digital representative, first the QR code is read by a scanner. Then the code is decrypted electronically by a processing machine such as cloud computing into the same DNA sequence as the DNA sequence in the ink using a scanning and decrypting algorithm. If the securely maintained data matches the accompanying data content stored in the QR code, then the QR code is verified. The DNA sequence corresponding to that encrypted digital representative is retrieved from the secure cloud-based data via the App (the “App” can be any suitable smartphone or similar application and may be registered through Apple and/or Droid). Its sequence corresponds to the physical sequence in the ink used for printing the QR code facilitating authentication. The database is hosted on an SQL database, which can be cloud-based. For authentication, the digital DNA sequence derived from the QR code must match the physical DNA sequence in the ink derived chemically using forensic techniques, including any of a variety of well known techniques, such as for instance amplification by polymerase chain reaction (PCR) to produce defined length amplicons with specific primer pairs, and if desired, confirmed by sequencing and resolved by a suitable electrophoresis method, such as for instance, by capillary electrophoresis.

### Example 2

The inclusion of a combination of multiple DNA Sequences and trace elements on the RFID tag and the encryption of the DNA sequences into electronic content of the RFID tag for authentication.

The combination of multiple DNA Sequences and trace elements are incorporated into the RFID tag. The combination of multiple DNA sequences and trace elements are encrypted into electronic bit streams stored with the data content on the RFID tag. The entire data content can be read by an RFID scanner which is configured to be operatively linked to a computer which is then used to access a secure online server for verification. The database is hosted locally, for example, using Microsoft Access. The code encrypted by the RFID signal (via a known or proprietary encryption coding method) and decrypted by a matching decode program at the receiving side. The combination of multiple DNA sequences and trace elements are then analyzed by technicians for authentication.

### Example 3

Track and trace history of a specific artwork.

Unique DNA markers and up converting phosphor (UCP) mixed with clear coating are used by an artist to identify art works. For instance, the DNA markers and UCP can be used to cover the artist's signature and/or a QR code. When artworks change hands to different owners, these artworks are scanned, and registered into a centralized cloud database to provide the latest registration of the artworks and the past history of ownerships and its whereabouts. To verify the authenticity of an artwork, first the QR code is scanned using pattern recognition to verify the DNA sequences which authenticate the artwork. Furthermore, for authentication, the digital DNA sequence derived from the QR code (or above the signature) must match the physical DNA sequence in the ink using analytical techniques, including any of a variety of well known forensic techniques, such as for instance amplification by polymerase chain reaction (PCR) to produce defined fragment length amplicons utilizing specific primer pairs, and if desired, confirmed by sequencing and resolved by a suitable electrophoresis method, such as for instance, by capillary electrophoresis.

### Example 4

Inclusion of unique DNA and QR codes to provide provenance and freshness.

Freshly caught fishes are processed and packaged with tags printed with DNA ink incorporated into QR codes which contain geolocation and time-stamping. The species, freshness, and origins can be verified from the supply chain to the end consumers. The ubiquity of the iPhone® platform allows the consumer to participate in the authentication scheme, quickly and easily. In addition, end-users can confirm freshness and expiration dates, connect to real-time or video technical support, identify local resources, easily place reorders, and participate in peer-to-peer selling. Furthermore, samples from the QR codes containing DNA can be submitted for authentication. The digital DNA sequence derived from the QR code must match the physical DNA sequence in the ink using analytical techniques, including any of a variety of well known forensic techniques, such as for instance amplification by polymerase chain reaction (PCR) to produce defined fragment length amplicons utilizing specific primer pairs, and if desired, confirmed by sequencing and resolved by a suitable electrophoresis method, such as for instance, by capillary electrophoresis.

### Example 5

The inclusion of a combination of DNA Sequence(s) and trace element(s) and/or small molecule(s) on the RFID tag and the encryption of the DNA sequence(s) and identity of the trace element(s) and/or small molecule(s) into electronic content of the RFID tag for authentication.

The combination of multiple DNA Sequences and trace elements and/or small molecules are incorporated into the RFID tag. The combination of DNA sequence(s) and trace element(s) and/or small molecule(s) are encrypted as electronic bit streams stored with the data content on the RFID tag. The entire data content can be read by an RFID scanner which is configured to a computer which is used to access a secure online server for verification. The code encrypted by the RFID signal and decrypted by a matching decode program at the receiving side. The combination of DNA sequence(s) and trace element(s) and/or small molecule(s) are then analyzed by technicians in a laboratory for authentication.

### Example 6

The inclusion of unique DNA markers and rapid readers in ink used to print a barcode and the encryption of the DNA sequence for authentication.

The sequences of DNA and the rapid reader color codes are encrypted into a numeric hash key to generate the numeric barcode. Barcode is printed using ink containing DNA marker directly onto an object using inkjet printer or onto a label which is attached to an object. For rapid screening of the barcode, first an ultraviolet light is used to excite fluorophore(s) in the label to produce a known visible dominant color which can be converted into a color code. Next, a proprietary barcode scanner is used to read the barcode. This information is sent to a server where software will extract the DNA sequence from the hash key and a color code from a Prolog database library. Finally a technician verifies the DNA sequence obtained from the key to DNA sequence using DNA analysis.

### Example 7

Inclusion of unique DNA sequences and/or peptides, or polypeptides in magnetic particulate coating used to make magnetic stripe card and the encryption of the DNA sequence for authentication.

The combination of multiple DNA Sequences and/or polypeptides, proteins, such as, but not limited to antigens, epitopes, and immunoglobulins are mixed with magnetic particles used to coat the magnetic stripe card such as credit card, ID card, etc. The combination of multiple DNA sequences and/or polypeptides/proteins are encrypted into electronic data written with the data content on the magnetic stripe card. The entire data content can be read by magnetic stripe reader which is configured to be operatively linked to a computer for a secure online verification. The code encrypted magnetically (via a known or proprietary encryption coding method) and decrypted by a matching decode program at the reading side. The combination of multiple DNA sequences and/or polypeptides/proteins are then analyzed in a laboratory for authentication.

### Example 8

The inclusion of unique DNA sequences and optical dyes used to produce optical card, and the encryption of the DNA sequences for authentication.

The combination of multiple DNA Sequences and optical dyes are mixed and used to coat an injected-mold optical media containing representative information in pits and grooves producing interfering patterns and holographic interfering patterns. The combination of multiple DNA sequences and characteristic optical dye compositions are encrypted into electronic data written with the data content onto these optical media. The entire data content can be read by laser and the signal is captured by a camera with software that transforms the representative data into readable information. This information is transmitted to a secure online verification. Multiple DNA sequences are then analyzed by technicians in a laboratory for authentication.

The description and examples provided herein are for illustration purposes only and are not intended to be taken as limiting the scope of the inventive concept. The patents and other references cited herein are hereby incorporated by reference in their entireties. In the event that a term defined herein is in conflict with the definition of the term as used one or more references or patents incorporated herein, then the meaning provided in the specification of this application is intended. The patents and other references cited herein are hereby incorporated by reference in their entireties.

We claim:

1. A verifiably identifiable object comprising:
a primary taggant encoding a readable encrypted first identifier of the object encrypted by a first method; and
a secondary taggant optionally encoding a readable encrypted second identifier of the object encrypted by a second method.

2. The object according to claim 1, wherein the primary taggant comprises one or more of a nucleic acid, an amino acid, a peptide, a polypeptide, a protein, a trace element or a small molecule.

3. The object according to claim 2, wherein the primary taggant comprises a nucleic acid, and the nucleic acid comprises a nucleic acid sequence encoding the readable first identifier.

4. The object according to claim 3, wherein the nucleic acid sequence is in a range from about 4 bases to about 20,000 bases.

5. The object according to claim 4, wherein the nucleic acid sequence is in a range from about 10 bases to about 10,000 bases.

6. The object according to claim 5, wherein the nucleic acid sequence is in a range from about 14 bases to about 2,000 bases.

7. The object according to claim 2, wherein the secondary taggant encoding a readable encrypted second identifier of the object comprises one or more of a bar code, a magnetic stripe, a hologram, an interference pattern, an optical medium, a microdot, a QR code or an RFID.

8. A method of identification and/or authentication of an object, the method comprising:
providing a primary taggant encoding a readable encrypted first identifier of the object encrypted by a first method;
providing a secondary taggant optionally encoding a readable encrypted second identifier of the object encrypted by a second method;
providing a searchable secure database encoding the first identifier and second identifier of the object reading the first identifier and the second identifier;
comparing the readings of the first identifier and the second identifier with the a searchable secure database encoding the first identifier and the second identifier of the object; and
thereby identifying the object as authentic or counterfeit.

9. The method according to claim 8, wherein the primary taggant comprises one or more of a nucleic acid, an amino acid, a peptide, a polypeptide, a protein, a trace element or a small molecule.

10. The method according to claim 8, wherein the primary taggant comprises a nucleic acid, and the nucleic acid comprises a nucleic acid sequence encoding the readable first identifier.

11. The object according to claim 10, wherein the nucleic acid sequence is in a range from about 4 bases to about 10,000 bases.

12. The object according to claim 11, wherein the nucleic acid sequence is in a range from about 10 bases to about 5,000 bases.

13. The object according to claim 12, wherein the nucleic acid sequence is in a range from about 14 bases to about 2,000 bases.

14. The method according to claim 8, wherein the secondary taggant encoding a readable encrypted second identifier of the object comprises one or more of a bar code, a magnetic stripe, a hologram, an interference pattern, an optical medium, a microdot, a QR code or an RFID.

15. A system for identification and/or authentication of an object, comprising:
a primary taggant encoding a readable first identifier of the object encrypted by a first method;
a secondary taggant optionally encoding a readable second identifier of the object encrypted by a second method; and
a searchable secure database encoding the first identifier and second identifier of the object.

16. The system according to claim 15, wherein the primary taggant comprises a nucleic acid, an amino acid, a peptide, a polypeptide, a protein, a trace element or a combination of one or more thereof.

17. The system according to claim 15, wherein the primary taggant comprises a nucleic acid, and the nucleic acid comprises a nucleic acid sequence encoding the readable first identifier.

18. The object according to claim 17, wherein the nucleic acid sequence is in a range from about 4 bases to about 10,000 bases.

19. The object according to claim 17, wherein the nucleic acid sequence is in a range from about 14 bases to about 2,000 bases.

20. The system according to claim 15, wherein the secondary taggant encoding a readable encrypted second identifier of the object comprises one or more of a bar code, a magnetic stripe, a hologram, an interference pattern, an optical medium, a microdot, a QR code or an RFID.
